(19) United States
(12) Patent Application Publication
(10) Pub. No.: US 2021/0276247 A1
(43) Pub. Date: Sep. 9, 2021

(54) MANUFACTURING APPARATUS

(71) Applicant: FUJIFILM BUSINESS INNOVATION CORP., Tokyo (JP)

(72) Inventor: Kentaro AGEISHI, Kanagawa (JP)

(73) Assignee: FUJIFILM BUSINESS INNOVATION CORP., Tokyo (JP)

(21) Appl. No.: 16/984,506

(22) Filed: Aug. 4, 2020

(30) Foreign Application Priority Data
Mar. 5, 2020 (JP) 2020-038219

(51) Int. Cl. B29C 64/118; B29C 64/245; B29C 64/236; B29C 64/209; B29C 64/241

(52) U.S. Cl. CPC B29C 64/118; B29C 64/245; B33Y 30/00; B29C 64/209; B29C 64/241; B29C 64/236

(57) ABSTRACT

A manufacturing apparatus includes: a table having a surface; a stacking unit that stacks layers of a manufacturing material along the surface to form a stack; and a forming unit that forms a layer of the manufacturing material along a side surface of the stack by ejecting the manufacturing material toward the side surface while moving along the side surface so as to traverse the plural layers forming the stack in a stacking direction of the stack.

### CROSS-REFERENCE TO RELATED APPLICATIONS

This application is based on and claims priority under 35 USC 119 from Japanese Patent Application No. 2020-038219 filed Mar. 5, 2020.

### BACKGROUND

### 1. Technical Field

The present disclosure relates to a manufacturing apparatus.

### 2. Related Art

JP-A-2018-049854 describes a wiring structure including a stacked part in which a first material having an insulation property is stacked with an opening, the opening having a portion in common with openings in vertically adjacent layers when viewed in plan view and a wiring part having a conductive integral structure which penetrates the opening and has a tip exposed from the opening at the penetrating end thereof.

### SUMMARY

Aspects of non-limiting embodiments of the present disclosure relate to increasing the strength of a manufactured article in a stacking direction, as compared with a configuration in which an article is manufactured only by a stacking unit that stacks layers of a manufacturing material along a surface of a table.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a manufacturing apparatus including: a table having a surface; a stacking unit that stacks layers of a manufacturing material along the surface to form a stack; and a forming unit that forms a layer of the manufacturing material along a side surface of the stack by ejecting the manufacturing material toward the side surface while moving along the side surface so as to traverse the plural layers forming the stack in a stacking direction of the stack.

### BRIEF DESCRIPTION OF THE DRAWINGS

Exemplary embodiment(s) of the present disclosure will be described in detail based on the following figures, wherein:

FIG. 1 is a view illustrating a schematic configuration of a manufacturing apparatus according to a first exemplary embodiment;

FIG. 2 is a view illustrating a schematic configuration of a first ejection unit or a second ejection unit according to the first exemplary embodiment;

FIG. 3 is a perspective view illustrating a manufactured article according to the first exemplary embodiment; and

FIG. 4 is a view illustrating a schematic configuration of a manufacturing apparatus according to a second exemplary embodiment.

### DETAILED DESCRIPTION

### First Exemplary Embodiment

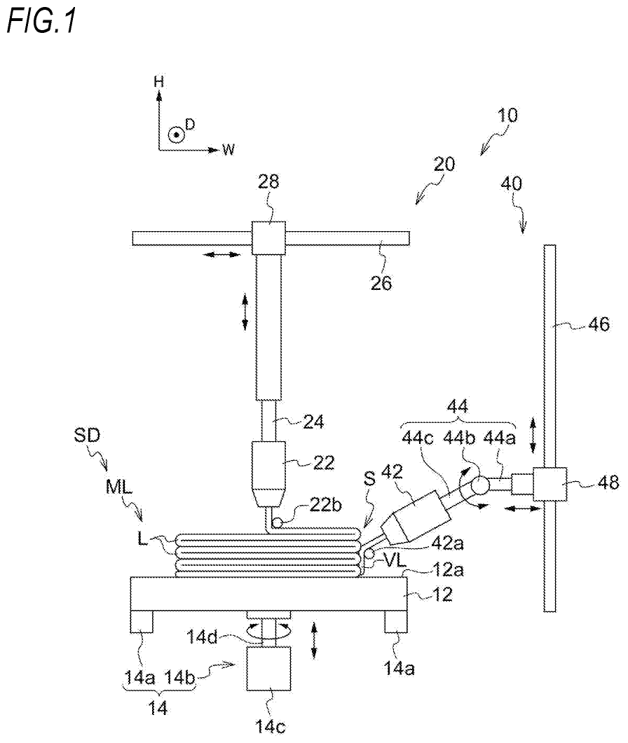

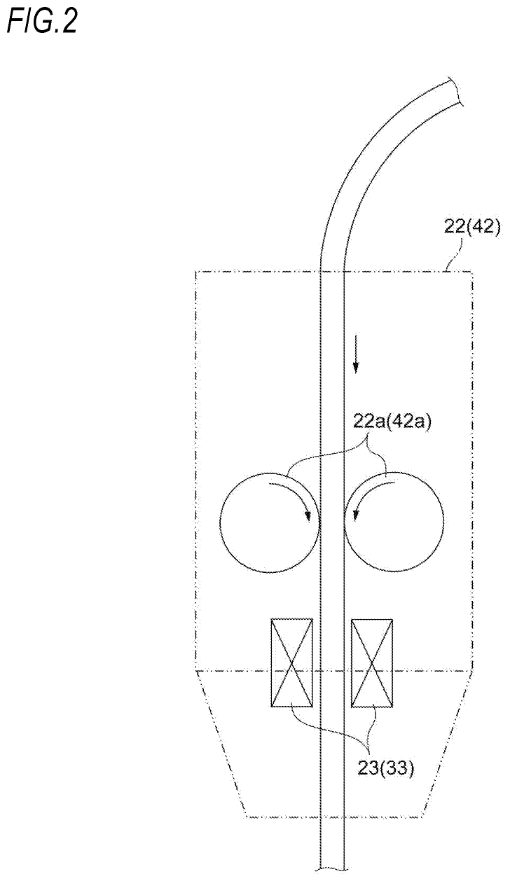

First, an example of a manufacturing apparatus according to a first exemplary embodiment of the present disclosure will be described based on FIGS. 1 and 2. The arrow H illustrated in the drawings indicates the apparatus vertical direction (vertical direction), the arrow W indicates the apparatus width direction (horizontal direction), and the arrow D indicates the apparatus depth direction (horizontal direction).

### (Manufacturing Apparatus 10)

A manufacturing apparatus 10 is a three-dimensional manufacturing apparatus (3D printer) of fused deposition modeling (FDM) type, and is an apparatus that manufactures an article SD by repeatedly stacking layers plural times according to layer data on plural layers.

As illustrated in FIG. 1, the manufacturing apparatus 10 includes a stage 12, a stage moving unit 14, a stacking unit 20, a forming unit 40, a supply unit (not illustrated), a controller (not illustrated), and a case (not illustrated). The supply unit (not illustrated) supplies a manufacturing material that forms the manufactured article SD to the stacking unit 20 and the forming unit 40. The controller (not illustrated) controls the overall operation of the manufacturing apparatus 10 according to data on plural layers made from three-dimensional data on the manufactured article SD. Details of the stacking unit 20 and the forming unit 40 will be described later.

### (Manufactured Article)

The article SD is manufactured by the stacking unit 20 and the forming unit 40 on a surface 12a of the stage 12 to be described later. The manufactured article SD is composed of a stack ML formed by the stacking unit 20 and a vertical layer VL formed by the forming unit 40.

### (Stack)

The stack ML is a three-dimensional object obtained by stacking, on the surface 12a of the stage 12, layers L of manufacturing material which are formed along the surface 12a by the stacking unit 20. The stack ML has, for example, a rectangular parallelepiped shape. Four side surfaces of the stack ML are referred to as side surfaces S. The shape of the stack ML is not limited to the rectangular parallelepiped shape.

### (Vertical Layer)

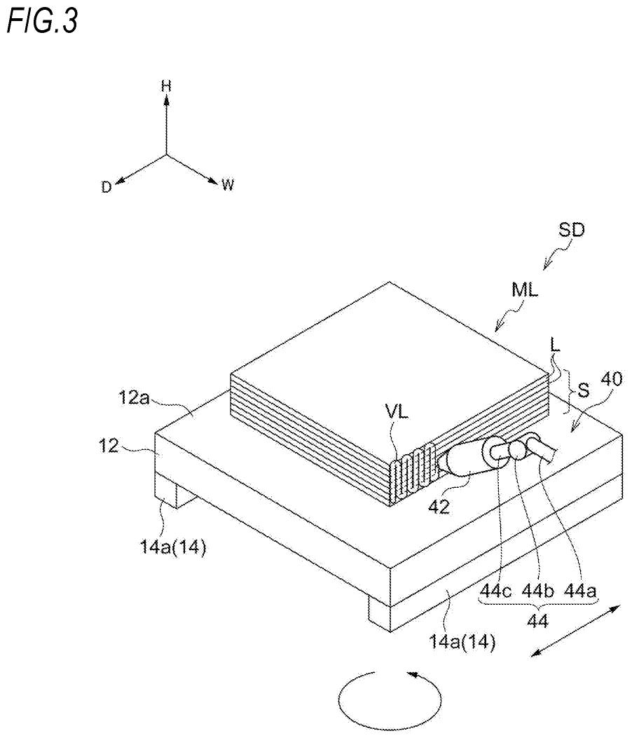

The vertical layer VL is a layer of manufacturing material formed by the forming unit 40 on the side surface S of the stack ML to extend along the side surface S. For example, the vertical layer VL is formed of a manufacturing material that meanders in the apparatus vertical direction toward the apparatus depth direction to extend across the plural layers L forming the stack ML in the stacking direction of the stack ML (see FIG. 3). For example, the vertical layer VL may be formed of a manufacturing material that meanders in the apparatus depth direction toward the apparatus vertical direction to extend across the plural layers L forming the stack ML in the stacking direction of the stack ML. Further, the vertical layer VL may be formed of a manufacturing material that extends in a spiral shape on the side surface S so as to traverse the plural layers L forming the stack ML in the stacking direction of the stack ML. The vertical layer VL is an example of a layer of manufacturing material along the side surface of the stack.

### (Manufacturing Material)

In the exemplary embodiment, the manufacturing material forming the stack ML and the vertical layer VL is a filament formed by impregnating a bundle of continuous fibers with a resin. For example, the bundle of continuous fibers is formed by bundling 3,000 carbon fibers having a thickness of 0.007 mm in a circular shape having a diameter of 0.4 mm. The resin is, for example, a thermoplastic resin such as polyolefin. For example, the manufacturing material is mounted on the supply unit (not illustrated) with being wound around two reels in advance, and is supplied to the stacking unit 20 and the forming unit 40 from the respective reels.

### (Stage)

The stage 12 is a flat plate-shaped member that is disposed below the stacking unit 20 to be described later and at one side in the apparatus width direction with respect to the forming unit 40 and has the surface 12a that is a horizontal surface facing upward. The stage 12 is an example of a table.

### (Stage Moving Unit)

The stage moving unit 14 is a mechanism including a translational moving unit 14a and a rotary lift unit 14b, and relatively moves the stage 12 with respect to the stacking unit 20 and the forming unit 40.

### (Translational Moving Unit)

The translational moving unit 14a is, for example, a mechanism including a linear actuator and a linear guide which are disposed below the stage 12, the linear actuator having a movable element that is movable in the apparatus depth direction. The movable element of the translational moving unit 14a is disposed on the lower surface at both end portions of the stage 12 in the apparatus width direction so as to be detachable from the stage 12. When the movable element of the translational moving unit 14a is in contact with the lower surface of the stage 12, the stage 12 is fixed in the apparatus depth direction and the apparatus width direction with respect to the movable element of the translational moving unit 14a by a positioning unit such as a positioning pin. Further, at this time, when the movable element of the translational moving unit 14a moves in the apparatus depth direction, the stage 12 moves in the apparatus depth direction together with the movable element. In the first exemplary embodiment, the translational moving unit 14a can reciprocate the surface 12a of the stage 12 in the apparatus depth direction (see FIG. 3). The translational moving unit 14a is an example of a surface moving unit.

### (Rotary Lift Unit)

The rotary lift unit 14b is a mechanism that is disposed below the stage 12 and that includes a rotary drive unit 14c and a lift unit 14d. The rotary drive unit 14c includes, for example, a motor having a rotation shaft around the vertical axis thereof. The lift unit 14d is a lift that protrudes upward from the rotary drive unit 14c and is capable of expanding and contracting in the apparatus vertical direction. The lift unit 14d expands upward in the apparatus vertical direction to lift the stage 12 and separate the stage 12 from the translational moving unit 14a. Further, when the lift unit 14d is lifting the stage 12, the lift unit 14d contracts downward in the apparatus vertical direction to lower the stage 12 and mount the stage 12 on the translational moving unit 14a.

The lift unit 14d is rotatable around the vertical axis by the rotary drive unit 14c. When the lift unit 14d is rotated by the rotary drive unit 14c while expanding upward in the apparatus vertical direction and lifting the stage 12, the surface 12a of the stage 12 that is being lifted by the lift unit 14d rotates around the vertical axis, i.e., the axis crossing the surface 12a. At this time, the stack ML formed on the surface 12a is changed in orientation with respect to the forming unit 40. The rotary lift unit 14b is an example of a first changing unit.

The rotary lift unit 14b lowers the stage 12 and mounts the stage 12 on the translational moving unit 14a from a state where it has lifted the stage 12 and has been rotated. At this time, the stage 12 is fixed in the apparatus depth direction and the apparatus width direction with respect to the movable element of the translational moving unit 14a.

### (Stacking Unit)

The stacking unit 20 includes a first ejection unit 22, a support portion 24, a horizontal frame 26, and a first moving unit 28. The stacking unit 20 stacks, on the surface 12a of the stage 12, the layers L of manufacturing material along the surface 12a to form the stack ML. The support portion 24 is, for example, a rod-shaped member that extends in the apparatus vertical direction, and supports the first ejection unit 22 on the lower end portion thereof. The upper end portion of the support portion 24 is connected to the first moving unit 28 to be described later. The horizontal frame 26 is disposed above the support portion 24, and is a rectangular frame-shaped member extending along a horizontal surface which is supported by the case (not illustrated) of the manufacturing apparatus 10.

### (First Ejection Unit)

The first ejection unit 22 is, for example, a nozzle-shaped member having an upper portion supported by the support portion 24. The first ejection unit 22 ejects a manufacturing material which is supplied from the supply unit (not illustrated) via an unwinding roller (not illustrated) from an outlet of a nozzle toward the surface 12a of the stage 12 in a state where the manufacturing material is heated and melted by a heater 23 (see FIG. 2). The first ejection unit 22 includes a pull-out roller pair 22a (see FIG. 2) and a pressure roller 22b. The pull-out roller pair 22a is a pair of roller members that sandwich a manufacturing material pulled out from the unwinding roller (not illustrated). The pull-out roller pair 22a pulls out the manufacturing material toward an outlet of the first ejection unit 22 to eject the manufacturing material from the first ejection unit 22. The pressure roller 22b is a roller member that presses the manufacturing material ejected from the first ejection unit 22 against the stage 12 or the layer L of manufacturing material.

### (First Moving Unit)

The first moving unit 28 is, for example, a mechanism that includes plural linear actuators (not illustrated) provided in the horizontal frame 26 and that has a movable element that is movable in the apparatus width direction and the apparatus vertical direction. The movable element of the first moving unit 28 is connected to the upper end portion of the support portion 24. The first moving unit 28 relatively moves the support portion 24 and the first ejection unit 22 with respect to the surface 12a of the stage 12. Specifically, when the movable element of the first moving unit 28 moves in the apparatus vertical direction, the first ejection unit 22 moves in the apparatus vertical direction together with the movable element. Further, when the movable element of the first moving unit 28 moves in the apparatus width direction, the first ejection unit 22 moves in the apparatus width direction together with the movable element. The relative movement of the first ejection unit 22 with respect to the stage 12 in the apparatus depth direction is performed by the stage moving unit 14. In other words, the first moving unit 28 uses the stage moving unit 14 as a moving unit that relatively moves the surface 12a of the stage 12 with respect to the first ejection unit 22 in the apparatus depth direction.

### (Forming Unit)

The forming unit 40 is disposed at the other side in the apparatus width direction with respect to the stage 12, and includes a second ejection unit 42, a support portion 44, a vertical frame 46, and a second moving unit 48. The forming unit 40 ejects the manufacturing material toward the side surface S of the stack ML formed by the stacking unit 20 so as to traverse the plural layers L forming the stack ML in the stacking direction of the stack ML while moving along the side surface S, and forms the vertical layer VL on the side surface S facing the forming unit 40. In the exemplary embodiment, the forming unit 40 ejects the manufacturing material toward the side surface S while moving so as to meander in the stacking direction of the stack ML toward the apparatus depth direction and traverse the plural layers L forming the stack ML in the stacking direction of the stack ML. The forming unit 40 may eject the manufacturing material while moving so as to meander in the apparatus depth direction toward the stacking direction of the stack ML and traverse the plural layers L forming the stack ML in the stacking direction of the stack ML. Further, the forming unit 40 may eject the manufacturing material while moving in a spiral shape on the side surface S so as to traverse the plural layers L forming the stack ML in the stacking direction of the stack ML. The vertical frame 46 is a rectangular frame-shaped member extending in the apparatus depth direction and the apparatus vertical direction which is supported by the case (not illustrated) of the manufacturing apparatus 10.

### (Second Ejection Unit)

The second ejection unit 42 is, for example, a nozzle-shaped member disposed at one side in the apparatus width direction with respect to the vertical frame 46. The second ejection unit 42 ejects the manufacturing material supplied from the supply unit (not illustrated) via the unwinding roller (not illustrated) from an outlet toward the side surface S in a state where the manufacturing material is heated and melted by a heater 33 (see FIG. 2). That is, the direction in which the manufacturing material is ejected by the forming unit 40 crosses the direction in which the manufacturing material is ejected by the stacking unit 20. The direction in which the manufacturing material is ejected by the forming unit 40 may be a direction inclined with respect to the horizontal direction as long as it crosses the direction in which the manufacturing material is ejected by the stacking unit 20 and also faces the side surface S. The second ejection unit 42 includes a pull-out roller pair 42a (see FIG. 2) and a pressure roller 42b. The pull-out roller pair 42a sandwiches the manufacturing material supplied from the unwinding roller (not illustrated), and pulls out the manufacturing material toward the outlet of the second ejection unit 42. The pull-out roller pair 42a is a pair of roller members that eject the manufacturing material from the second ejection unit 42. The pressure roller 42b is a roller member that presses the manufacturing material ejected from the second ejection unit 42 against the side surface S of the stack ML.

### (Support Portion)

The support portion 44 is disposed between the second ejection unit 42 and the vertical frame 46, and includes a first arm 44a, a joint 44b, and a second arm 44c. The support portion 44 supports the second ejection unit 42. The first arm 44a is a rod-shaped member extending in the apparatus width direction, and the end portion of the first arm 44a at one side in the apparatus width direction is connected to the second moving unit 48 to be described later. The joint 44b is disposed on the end portion of the first arm 44a at the other side in the apparatus width direction, and includes, for example, a motor (not illustrated) having a rotation shaft in the apparatus depth direction. The second arm 44c is a rod-shaped member that connects the second ejection unit 42 to the joint 44b. The support portion 44 changes the angle at which the second ejection unit 42 ejects the manufacturing material with respect to the vertical direction according to the rotation of the motor (not illustrated) provided in the joint 44b. The joint 44b is an example of a second changing unit.

### (Second Moving Unit)

The second moving unit 48 is, for example, a mechanism that includes plural linear actuators (not illustrated) provided in the vertical frame 46 and that has a movable element that is movable in the apparatus width direction and the apparatus vertical direction. The movable element of the second moving unit 48 is connected to the end portion of the first arm 44a at the other side in the apparatus width direction. The second moving unit 48 relatively moves the support portion 44 and the second ejection unit 42 with respect to the stage 12 and the side surface S of the stack ML formed in the shape of the surface 12a of the stage 12. Specifically, when the movable element of the second moving unit 48 moves in the apparatus vertical direction, the second ejection unit 42 moves in the apparatus vertical direction together with the movable element. Further, when the movable element of the second moving unit 48 moves in the apparatus width direction, the second ejection unit 42 moves in the apparatus width direction together with the movable element. The relative movement of the second ejection unit 42 with respect to the stage 12 and the side surface S in the apparatus depth direction is performed by the stage moving unit 14. In other words, the second moving unit 48 uses the stage moving unit 14 as a moving unit that relatively moves the surface 12a of the stage 12 with respect to the second ejection unit 42 in the apparatus depth direction. That is, the first moving unit 28 and the second moving unit 48 share the stage moving unit 14 as a moving unit that relatively moves the surface 12a of the stage 12 with respect to the first ejection unit 22 and the second ejection unit 42 in the apparatus depth direction.

### (Method of Manufacturing Article)

Next, a method of manufacturing the article SD by the manufacturing apparatus 10 of the first exemplary embodiment will be described.

First, the manufacturing apparatus 10 controls operations of the stacking unit 20 and the stage 12 by the controller (not illustrated) to form the stack ML on the surface 12a of the stage 12 based on data on plural layers made from three-dimensional data on the manufactured article SD. Specifically, the controller (not illustrated) controls operations of the first ejection unit 22 connected to the first moving unit 28 and the stage 12 connected to the stage moving unit 14 to form the stack ML by ejecting the manufacturing material while relatively moving the first ejection unit 22 with respect to the surface 12a.

Next, the manufacturing apparatus 10 controls operations of the forming unit 40 and the stage 12 by the controller (not illustrated) to form the vertical layer VL on the side surface S of the stack ML facing the forming unit 40 based on data on plural layers made from three-dimensional data on the manufactured article SD. Specifically, the controller (not illustrated) controls operations of the second ejection unit 42 connected to the second moving unit 48 and the stage 12 connected to the stage moving unit 14 to form the vertical layer VL by ejecting the manufacturing material while relatively moving the second ejection unit 42 with respect to the surface 12a.

After forming the vertical layer VL on the side surface S facing the forming unit 40, the manufacturing apparatus 10 rotates the stage 12 by the rotary lift unit 14b, for example, 90° clockwise when viewed from above. After rotating the stage 12, the manufacturing apparatus 10 controls operations of the forming unit 40 and the stage 12 to form the vertical layer VL on the side surface S facing the forming unit 40 after the rotation. By repeating this operation, the vertical layer VL is formed on all of the four side surfaces S of the stack ML.

In this way, with the formation of the stack ML and the vertical layer VL, the article SD is manufactured.

The vertical layer VL may be formed simultaneously with the formation of the stack ML.

### (Actions/Effects)

Next, actions of the first exemplary embodiment will be described. In this description, when a comparative embodiment of the exemplary embodiment is described using the same components as in the manufacturing apparatus 10 of the first exemplary embodiment, the reference numerals and names of the components will be used as they are.

The manufacturing apparatus 10 according to the first exemplary embodiment has a configuration (first configuration) in which the forming unit 40 forms the vertical layer VL by ejecting the manufacturing material toward the side surface S while moving along the side surface S so as to traverse the plural layers L forming the stack ML in the stacking direction of the stack ML. The article SD manufactured by the manufacturing apparatus 10 has a higher strength in the stacking direction of the stack ML by including the vertical layer VL formed by the forming unit 40, as compared with a configuration in which the manufactured article is composed only of the stack. Accordingly, the manufacturing apparatus 10 having the first configuration increases the strength in the stacking direction of the manufactured article SD, as compared with a configuration in which the manufactured article is formed only by the stacking unit that stacks layers of manufacturing material along the surface of a table.

Further, the manufacturing apparatus 10 according to the first exemplary embodiment has a configuration (second configuration) in which the stacking unit 20 includes the first moving unit 28 and the forming unit 40 includes the second moving unit 48. Accordingly, the manufacturing apparatus 10 having the second configuration may be less expensive than a configuration in which one ejection unit is moved by a vertical articulated robot having six or more axes to form a stack and a layer along the side surface of the stack.

Further, the manufacturing apparatus 10 according to the first exemplary embodiment has a configuration (third configuration) in which the first moving unit 28 and the second moving unit 48 share the translational moving unit 14a as a moving unit that relatively moves the stage 12 with respect to the first ejection unit 22 and the second ejection unit 42 in the apparatus depth direction. Accordingly, the manufacturing apparatus 10 having the third configuration may provide a simpler configuration for the first moving unit and the second moving unit, as compared with a configuration in which the moving unit that moves the first ejection unit and the second ejection unit in the apparatus depth direction is provided in each of the first moving unit and the second moving unit.

Further, the manufacturing apparatus 10 according to the first exemplary embodiment has a configuration (fourth configuration) in which the stage moving unit 14 is capable of reciprocating the stage 12 in the apparatus depth direction. Accordingly, the manufacturing apparatus 10 having the fourth configuration may form the vertical layer VL after forming the stack ML.

Further, the manufacturing apparatus 10 according to the first exemplary embodiment has a configuration (fifth configuration in which the rotary lift unit 14b is further provided as an example of the first changing unit that changes the orientation of the stack ML formed on the surface 12a with respect to the forming unit 40. The manufacturing apparatus 10 may form the vertical layer VL on the four side surfaces S of the stack ML by including the rotary lift unit 14b. Accordingly, the manufacturing apparatus 10 having the fifth configuration may form a layer along the side surface S in a wide range of the side surface S of the stack ML.

Further, the manufacturing apparatus 10 according to the first exemplary embodiment has a configuration (sixth configuration) in which the rotary lift unit 14b which is an example of the first changing unit rotates the stage 12 around the axis crossing the surface 12a. That is, the manufacturing apparatus 10 according to the exemplary embodiment has a configuration in which the first changing unit changes the orientation of the stack ML formed on the surface 12a with respect to the forming unit 40 by rotating the stage 12 around the axis crossing the surface 12a. Accordingly, the manufacturing apparatus 10 having the sixth configuration may provide a simpler configuration for the first changing unit, as compared with a configuration in which the forming unit 40 is moved around the stack ML.

Further, the manufacturing apparatus 10 according to the first exemplary embodiment has a configuration (seventh configuration) in which the forming unit 40 includes the joint 44b that changes the angle at which the second ejection unit 42 ejects the manufacturing material with respect to the vertical direction. Accordingly, the manufacturing apparatus 10 having the seventh configuration may form the vertical layer VL on a portion of the stack ML near the surface 12a of the stage 12.

Further, the manufacturing apparatus 10 according to the first exemplary embodiment has a configuration (eighth configuration) in which the manufacturing material is a filament formed by impregnating a bundle of continuous fibers with a resin. Accordingly, the manufacturing apparatus 10 having the eighth configuration increases the strength in the stacking direction of the manufactured article formed of the filament in which the continuous fibers are impregnated with the resin.

### Second Exemplary Embodiment

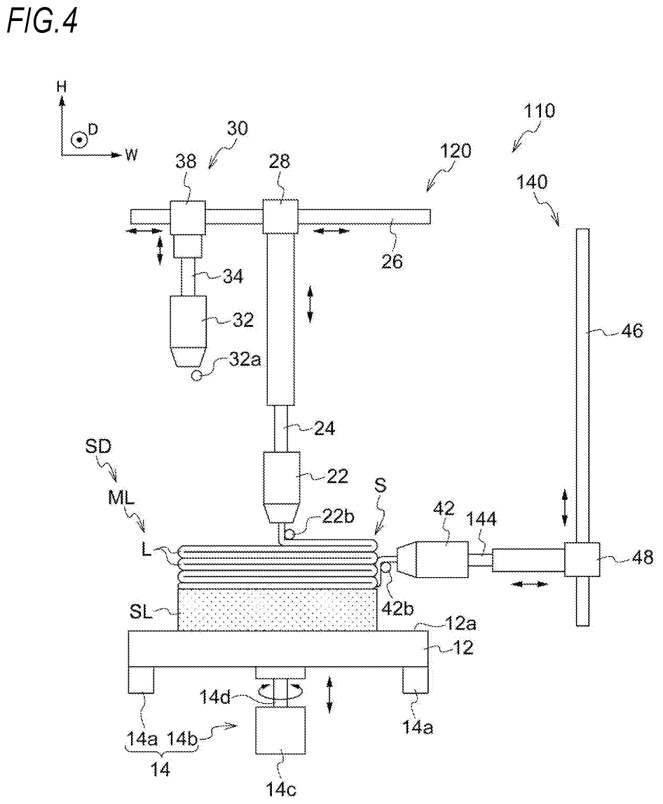

Next, an example of the manufacturing apparatus according to a second exemplary embodiment of the present disclosure will be described based on FIG. 4. Descriptions of the second exemplary embodiment will be mainly focused on differences from the first exemplary embodiment.

### (Configuration)

As illustrated in FIG. 4, the manufacturing apparatus 110 according to the second exemplary embodiment includes a stacking unit 120 having a configuration different from that of the stacking unit 20 instead of the stacking unit 20 according to the first exemplary embodiment. Further, the manufacturing apparatus 110 includes a forming unit 140 having a configuration different from that of the forming unit 40 instead of the forming unit 40 according to the first exemplary embodiment.

### (Stacking Unit)

The stacking unit 120 has a configuration in which the stacking unit 20 according to the first exemplary embodiment further includes a support layer forming unit 30. The stacking unit 120 forms a support layer SL on the surface 12a of the stage 12 by the support layer forming unit 30. The support layer SL is a three-dimensional object formed of a support material. The support material is, for example, a filament formed of a thermoplastic resin such as polypropylene. The support material is mounted on a supply unit (not illustrated) with being wound around a reel and the like and is supplied to the support layer forming unit 30 from the supply unit (not illustrated). The support layer forming unit 30 forms the support layer SL by ejecting the support material supplied from the supply unit (not illustrated). The support layer forming unit 30 forms the upper surface of the support layer SL into a shape along the bottom surface of the stack ML. Further, the support layer forming unit 30 forms the side surface of the support layer SL into a shape along the bottom side surface of the stack ML. The stacking unit 120 forms the stack ML on the support layer SL.

### (Support Layer Forming Unit)

The support layer forming unit 30 includes a third ejection unit 32, a support portion 34, and a third moving unit 38. The third ejection unit 32 includes, for example, a nozzle-shaped member, and ejects the support material toward the surface 12a of the stage 12 in a state where the support material is heated and melted. Further, the third ejection unit 32 includes a pressure roller 32a. The pressure roller 32a presses the support material ejected from the third ejection unit 32 against the stage 12. The support portion 34 is, for example, a rod-shaped member extending in the apparatus vertical direction, and supports the third ejection unit 32 on the lower end portion thereof. The upper end portion of the support portion 34 is connected to the third moving unit 38 to be described later.

### (Third Moving Unit)

The third moving unit 38 is, for example, a mechanism that includes plural linear actuators (not illustrated) provided in the horizontal frame 26 and that has a movable element that is movable in the apparatus width direction and the apparatus vertical direction. The movable element of the third moving unit 38 is connected to the upper end portion of the support portion 34. The third moving unit 38 relatively moves the support portion 34 and the third ejection unit 32 with respect to the surface 12a of the stage 12. Specifically, when the movable element of the third moving unit 38 moves in the apparatus vertical direction, the third ejection unit 32 moves in the apparatus vertical direction together with the movable element. Further, when the movable element of the third moving unit 38 moves in the apparatus width direction, the third ejection unit 32 moves in the apparatus width direction together with the movable element. The relative movement of the third ejection unit 32 with respect to the stage 12 in the apparatus depth direction is performed by the stage moving unit 14. In other words, the third moving unit 38 uses the stage moving unit 14 as a moving unit that relatively moves the surface 12a of the stage 12 with respect to the third ejection unit 32 in the apparatus depth direction.

### (Forming Unit)

The forming unit 140 has a configuration in which the support portion 44 according to the first exemplary embodiment is replaced with a support portion 144. The support portion 144 is a rod-shaped member that is disposed between the second ejection unit 42 and the vertical frame 46 and extends in the apparatus width direction. The support portion 144 connects the second ejection unit 42 to the second moving unit 48.

Except for the above description, the second exemplary embodiment has the same configuration as the first exemplary embodiment.

### (Method of Manufacturing Article)

Next, a method of manufacturing the article SD in the second exemplary embodiment will be described.

First, the controller (not illustrated) controls operations of the support layer forming unit 30 and the stage 12 to form the support layer SL on the surface 12a of the stage 12 based on data on plural layers made from three-dimensional data on the manufactured article SD. Specifically, the controller (not illustrated) controls operations of the third ejection unit 32 connected to the third moving unit 38 and the stage 12 connected to the stage moving unit 14 to form the support layer SL by ejecting the support material while relatively moving the third ejection unit 32 with respect to the surface 12a.

Next, the controller (not illustrated) controls operations of the stacking unit 120 and the stage 12 to form the stack ML on the support layer SL based on data on plural layers made from three-dimensional data on the manufactured article SD.

Next, the controller (not illustrated) controls operations of the forming unit 140 and the stage 12 to form the vertical layer VL on the side surface S of the stack ML based on data on plural layers made from three-dimensional data on the manufactured article SD. The vertical layer VL may be formed simultaneously with the formation of the stack ML.

In this way, with the formation of the stack ML and the vertical layer VL on the support layer SL, the article SD is manufactured.

### (Actions/Effects)

The manufacturing apparatus 110 according to the second exemplary embodiment has a configuration (ninth configuration) in which the stacking unit 120 forms the support layer SL on the surface 12a of the stage 12 and then forms the stack ML on the support layer SL. That is, the manufacturing apparatus 110 according to the second exemplary embodiment has the ninth configuration instead of the seventh configuration of the manufacturing apparatus 10 according to the first exemplary embodiment. Accordingly, the manufacturing apparatus 10 having the ninth configuration may form the vertical layer VL on a portion of the stack ML near the surface 12a of the stage 12.

Actions of the manufacturing apparatus 110 other than actions caused by the manufacturing apparatus 110 having the ninth configuration instead of the seventh configuration of the manufacturing apparatus 10 of the first exemplary embodiment described above are similar to those of the first exemplary embodiment.

As described above, the specific exemplary embodiments of the present disclosure have been described in detail, but the present disclosure is not limited to the above exemplary embodiments, and various modifications, changes, and improvements thereof are possible within the scope of the technical idea of the present disclosure.

For example, the manufacturing apparatus of the exemplary embodiment forms the manufactured article SD on the surface 12a of the stage 12 connected to the stage moving unit 14. However, the manufacturing apparatus according to the exemplary embodiment of the present disclosure may include an endless belt that circularly reciprocates in the posture of extending in the apparatus depth direction, instead of the stage 12 connected to the stage moving unit 14, and to form the manufactured article SD on the outer surface of the endless belt.

Further, in the exemplary embodiment, the manufacturing apparatus 10 includes the translational moving unit 14a as an example of a surface moving unit. However, the manufacturing apparatus according to the exemplary embodiment of the present disclosure may include no surface moving unit. For example, the manufacturing apparatus according to the exemplary embodiment of the present disclosure may have a configuration in which, instead of the surface moving unit, the moving unit that moves the first ejection unit and the second ejection unit in the apparatus depth direction is provided in each of the first moving unit and the second moving unit. Further, the manufacturing apparatus according to the exemplary embodiment of the present disclosure may include both the moving unit that moves the first ejection unit and the second ejection unit in the apparatus depth direction and the surface moving unit.

Further, in the exemplary embodiment, the manufacturing apparatus 10 includes the rotary lift unit 14b as an example of the first changing unit. However, the first changing unit according to the present disclosure is not limited to the rotary lift unit 14b. For example, the manufacturing apparatus 10 may move the forming unit 40 around the stack ML by a robot arm and the like. Further, the manufacturing apparatus according to the exemplary embodiment of the present disclosure may include no first changing unit.

Further, in the exemplary embodiment, the first ejection unit 22 moves in the apparatus width direction and the apparatus vertical direction by the first moving unit 28 including the plural linear actuators provided in the horizontal frame 26. However, the first ejection unit 22 may move in the apparatus width direction and the apparatus vertical direction by a moving unit having a movable element that is movable along a virtual surface inclined in the apparatus depth direction with respect to the horizontal surface.

Further, in the exemplary embodiment, the filament wound around two reels in advance is mounted on the supply unit (not illustrated), and the supply unit supplies the filament to the stacking unit 20 and the forming unit 40. However, the supply unit according to the exemplary embodiment of the present disclosure may include two impregnation devices that impregnate a bundle of continuous fibers with a resin to form the filament. In this configuration, bundles of continuous fibers wound around two reels in advance is mounted on the supply unit, and the supply unit supplies filaments formed by impregnating the respective bundles of continuous fibers with the resin by the two impregnation devices to the stacking unit 20 and the forming unit 40.

Further, in the exemplary embodiment, the stacking unit 20 and the forming unit 40 eject a filament formed by impregnating a bundle of continuous fibers with a resin as a manufacturing material to form the manufactured article SD composed of the stack ML and the vertical layer VL. However, the stacking unit 20 and the forming unit 40 according to the exemplary embodiment of the present disclosure are not limited to a configuration in which a filament formed by impregnating a bundle of continuous fibers with a resin is ejected as a manufacturing material. For example, the stacking unit 20 and the forming unit 40 may eject a filament formed only of a thermoplastic resin such as polyolefin as a manufacturing material to form a manufactured article composed of a stack and a vertical layer.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A manufacturing apparatus comprising:
a table having a surface;
a stacking unit that stacks layers of a manufacturing material along the surface to form a stack; and
a forming unit that forms a layer of the manufacturing material along a side surface of the stack by ejecting the manufacturing material toward the side surface while moving along the side surface so as to traverse the plurality of layers forming the stack in a stacking direction of the stack.

2. The manufacturing apparatus according to claim 1, wherein
the stacking unit includes
a first ejection unit that ejects the manufacturing material toward the surface, and
a first moving unit that relatively moves the first ejection unit with respect to the surface, and
the forming unit includes
a second ejection unit that ejects the manufacturing material toward the side surface, and
a second moving unit that relatively moves the second ejection unit with respect to the side surface.

3. The manufacturing apparatus according to claim 2, wherein
the first moving unit and the second moving unit share a surface moving unit that moves the surface in a crossing direction that crosses (i) a direction in which the manufacturing material is ejected by the first ejection unit and (ii) a direction in which the manufacturing material is ejected by the second ejection unit, as a moving unit that relatively moves the surface in the crossing direction with respect to the first ejection unit and the second ejection unit.

4. The manufacturing apparatus according to claim 3, wherein the surface moving unit can reciprocate the surface in the crossing direction.

5. The manufacturing apparatus according to claim 1, further comprising:
a first changing unit that changes an orientation of the stack with respect to the forming unit.

6. The manufacturing apparatus according to claim 2, further comprising:
a first changing unit that changes an orientation of the stack with respect to the forming unit.

7. The manufacturing apparatus according to claim 3, further comprising:
a first changing unit that changes an orientation of the stack with respect to the forming unit.

8. The manufacturing apparatus according to claim 4, further comprising:
a first changing unit that changes an orientation of the stack with respect to the forming unit.

9. The manufacturing apparatus according to claim 5, wherein the first changing unit changes the orientation by rotating the surface on which the stack is formed around an axis crossing the surface.

10. The manufacturing apparatus according to claim 6, wherein the first changing unit changes the orientation by rotating the surface on which the stack is formed around an axis crossing the surface.

11. The manufacturing apparatus according to claim 7, wherein the first changing unit changes the orientation by rotating the surface on which the stack is formed around an axis crossing the surface.

12. The manufacturing apparatus according to claim 8, wherein the first changing unit changes the orientation by rotating the surface on which the stack is formed around an axis crossing the surface.

13. The manufacturing apparatus according to claim 1, wherein the forming unit includes a second changing unit that changes an angle at which the manufacturing material is ejected with respect to a vertical direction.

14. The manufacturing apparatus according to claim 2, wherein the forming unit includes a second changing unit that changes an angle at which the manufacturing material is ejected with respect to a vertical direction.

15. The manufacturing apparatus according to claim 3, wherein the forming unit includes a second changing unit that changes an angle at which the manufacturing material is ejected with respect to a vertical direction.

16. The manufacturing apparatus according to claim 4, wherein the forming unit includes a second changing unit that changes an angle at which the manufacturing material is ejected with respect to a vertical direction.

17. The manufacturing apparatus according to claim 5, wherein the forming unit includes a second changing unit that changes an angle at which the manufacturing material is ejected with respect to a vertical direction.

18. The manufacturing apparatus according to claim 6, wherein the forming unit includes a second changing unit that changes an angle at which the manufacturing material is ejected with respect to a vertical direction.

19. The manufacturing apparatus according to claim 1, wherein the stacking unit forms a support layer on the surface and then forms the stack on the support layer.

20. The manufacturing apparatus according to claim 1, wherein the manufacturing material is a filament formed by impregnating a bundle of continuous fibers with a resin.
